(19) United States
(12) Patent Application Publication
(10) Pub. No.: US 2015/0239740 A1
(43) Pub. Date: Aug. 27, 2015

(54) METHOD FOR FABRICATING POROUS CARBON MATERIAL

(71) Applicant: SUMITOMO ELECTRIC INDUSTRIES, LTD., Osaka-shi, Osaka (JP)

(72) Inventors: Shinji Ishikawa, Yokohama-shi (JP); Kazuya Kuwahara, Yokohama-shi (JP)

(21) Appl. No.: 14/436,471

(22) PCT Filed: Oct. 15, 2013
(86) PCT No.: PCT/JP2013/077985

§ 371 Date: Apr. 16, 2015

(30) Foreign Application Priority Data
Oct. 16, 2012 (JP) 2012-228942

(51) Int. Cl. C01B 31/02

(52) U.S. Cl. CPC C01B 31/02

(57) ABSTRACT

A method for fabricating a porous carbon is provided. The method comprises the steps of: exposing a metal carbide to a heated atmosphere of a first gas to produce a porous carbon material and a metal chloride, the metal carbide containing a first metal and carbon, the first gas containing chlorine gas, and the metal chloride containing the first metal and chlorine; reacting the metal chloride with a second gas in a heated atmosphere to produce a metal oxide and a third gas, the second gas containing oxygen gas, the metal oxide containing the first metal and oxygen, and the third gas containing chlorine gas; and recovering chlorine gas from the third gas, the chlorine gas recovered being used as the chlorine gas for the first gas.

### TECHNICAL FIELD

The present invention relates to a method for fabricating a porous carbon material.

### BACKGROUND ART

Patent Document 1 discloses a method for fabricating a porous active carbon, and Patent Document 2 discloses a method for fabricating a porous carbon material. In the fabricating method disclosed in Patent Document 2, silicon carbide (SiC) is subjected to chlorine gas (Cl₂) that is heated to a temperature of 1000 degrees Celsius or higher. Patent Document 2 discloses that the silicon carbide is the purified and densified in order to fabricate a porous carbon material with fine pores.

Non-Patent Document 1 relates to a carbon material having nano-order fine pores. In Non-Patent Document 1, a carbon material having fine pores is produced by treating carbide with chlorine. Silicon carbide or the like can be used as a raw material for the carbide. Non-Patent Document 1 indicates that the porosity and pore size distribution of a carbon material can be controlled depending upon carbide used in the reaction.

### CITATION LIST

### Patent Literature

Patent Document 1: U.S. Pat. No. 3,066,099 document

Patent Document 2: Japanese Patent Application Publication No. H02-184511

Patent Document 3: US Patent Publication No. 2006/0251565

### Non Patent Literature

Non-Patent Document 1: Volker Presser, Min Heon, and Yury Gogotsi, “Carbide-Derived Carbons From Porous Networks to Nanotubes and Graphene,” ADVANCED FUNCTIONAL MATERIALS, pp. 810-833 (2011)

### SUMMARY OF INVENTION

### Technical Problem

However, according to the methods for fabricating porous carbon materials disclosed in Patent Documents 1 and 2 and Non-Patent Document 1, fabricating the porous carbon materials on an industrial scale results in that a large amount of chlorine gas is needed therefor and that the chlorine gas thus consumed causes problems such as environmental load.

An object of one aspect of the present invention is to provide a method for fabricating a porous carbon material, and the method enables the efficient use of chlorine gas and the reduction in an environment burden caused by chlorine gas.

### Solution to Problem

One aspect of the present invention relates to a method for fabricating a porous carbon material. This method comprises the steps of: exposing a metal carbide to a heated atmosphere of a first gas to produce a porous carbon material and a metal chloride, the metal carbide containing a first metal and carbon, the first gas containing chlorine gas, and the metal chloride containing the first metal and chlorine; reacting the metal chloride with a second gas in a heated atmosphere to produce a metal oxide and a third gas, the second gas containing oxygen gas, the metal oxide containing the first metal and oxygen, and the third gas containing chlorine gas; and recovering chlorine gas from the third gas, the chlorine gas recovered being used as the chlorine gas for the first gas.

### Advantageous Effects of Invention

One aspect of the present invention provides a method for fabricating a porous carbon material, and the method enables the efficient use of chlorine gas and the reduction in an environment burden caused by chlorine gas.

### BRIEF DESCRIPTION OF DRAWINGS

FIG. 1 is a view showing the primary steps in a method for fabricating a porous carbon material according to one embodiment.

FIG. 2 is a view showing the primary steps in a method for fabricating a porous carbon material according to the embodiment.

FIG. 3 is a schematic view showing the structure of an apparatus for processing metal chloride which is advantageously used in the fabricating method according to the embodiment.

FIG. 4 is a schematic view showing the structure of an apparatus for processing metal chloride which is advantageously used in the fabricating method according to the embodiment.

FIG. 5 is a schematic view showing the structure of an apparatus for metal carbide and metal chloride used in another method.

### DESCRIPTION OF EMBODIMENTS

A number of modes according to the present invention will now be explained below. A method for fabricating a porous carbon material according to one mode of the present invention comprises the steps of: exposing a metal carbide to a heated atmosphere of a first gas to produce a porous carbon material and a metal chloride, the metal carbide containing a first metal and carbon, the first gas containing chlorine gas, and the metal chloride containing the first metal and chlorine; reacting the metal chloride with a second gas in a heated atmosphere to produce a metal oxide and a third gas, the second gas containing oxygen gas, the metal oxide containing the first metal and oxygen, and the third gas containing chlorine gas; and recovering chlorine gas from the third gas, the chlorine gas recovered being used as the chlorine gas for the first gas.

In this fabricating method, the metal chloride, which is produced together with the porous carbon material, reacts with oxygen gas of the second gas to produce the third gas and the metal oxide from the metal chloride, and chlorine gas is recovered from the third gas. The chlorine gas thus recovered can be used as chlorine gas for use in the first gas, which enables the reuse of chlorine gas in the production of the porous carbon material, thereby demonstrating the cyclic use of chlorine gas. This fabricating method allows the efficient use of chlorine gas and the reduction in an environment burden due to chlorine gas.

Further, in the fabricating method according to one mode of the present invention, the metal carbide can contain at least one of aluminum carbide, boron carbide, silicon carbide, titanium carbide, tungsten carbide or molybdenum carbide. These metal carbides enable the first step of producing the porous carbon material to be carried out in a preferred manner.

Furthermore, in the fabricating method according to one mode of the present invention, the first gas can be heated to a temperature of not lower than 500 degrees Celsius and not higher than 1500 degrees Celsius. In the temperature range of not lower than 500 degrees Celsius and not higher than 1500 degrees Celsius, a chemical reaction between the metal carbide and the first gas that contains chlorine gas to produce the porous carbon material.

In addition, in the fabricating method according to one mode of the present invention, the metal carbide may be silicon carbide and the first gas is heated to a temperature of not lower than 1000 degrees Celsius and not higher than 1300 degrees Celsius. The temperature range of not lower than 1000 degrees Celsius and not higher than 1300 degrees Celsius can promote the reaction between the silicon carbide and the first gas that contains chlorine gas, thereby producing the porous carbon material more efficiently.

In addition, in the fabricating method according to one mode of the present invention, the second gas may be heated to a temperature of not lower than 800 degrees Celsius. The metal chloride can reacts with the second gas containing oxygen gas within a temperature range of not lower than 800 degrees Celsius, thereby producing chlorine gas.

In addition, in the fabricating method according to one mode of the present invention, oxygen is supplied in the second step at a quantity that is lower than a stoichiometric ratio of the metal chloride. The quantity of oxygen gas remaining in the gas that is produced in the second step can be reduced thereby.

In addition, in the fabricating method according to one mode of the present invention, the metal oxide obtained in the second step is mixed with a carbon raw material, and the carbon raw material and the metal oxide thus mixed is heated so as to cause a thermal reaction thereby forming a carbide, and the carbide is used as a carbide raw material in chlorination carried out in the first step. This allows the reuse of the first metal contained in the metal oxide to provide a cyclic process, so that the first metal can be efficiently used.

In addition, in the fabricating method according to one mode of the present invention, the metal oxide obtained in the second step is mixed with a carbon raw material, and the carbon raw material and the metal oxide thus mixed is heated so as to cause a thermal reaction to form a carbide used as a raw material in chlorination carried out in the first step, and the metal element of the carbide may be one of silicon and titanium. Using silicon or titanium enables the formation of the metal oxide in a preferred manner, and ensures the possibility of a thermodynamic reaction in which the above element reacts with carbon to cyclically produce metal carbide.

In addition, in a fabricating method according to one mode of the present invention, the metal oxide obtained in the second step is mixed with a carbon raw material, and the carbon raw material and the metal oxide thus mixed is heated to a temperature of not lower than 1400 degrees Celsius and not higher than 2000 degrees Celsius to cause a thermal reaction to form a carbide, and the atmosphere in this reaction is an inert gas atmosphere. Within the temperature range of not lower than 1400 degrees Celsius and not higher than 2000 degrees Celsius, the metal oxide and the carbon react to produce the metal carbide.

In addition, in the fabricating method according to one mode of the present invention, a molar ratio of metal and carbon in a process in which a chemical reaction of a mixture formed by mixing the metal oxide in the second step with a carbon raw material is caused by heating is not lower than a stoichiometric ratio in a chemical reaction which produces metal carbide by consuming the oxygen component of metal oxide to produce carbon monoxide gas. This condition allows the metal carbide to be produced in a preferred manner.

Detailed explanations of embodiments of the method for fabricating a porous carbon material according to the present invention will now be made by referring to the appended drawings. Moreover, the identical parts are denoted by the identical reference symbols in the descriptions of the drawings, and duplicate explanations are omitted.

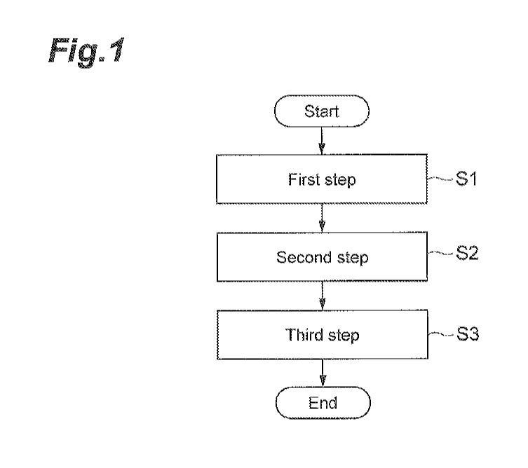

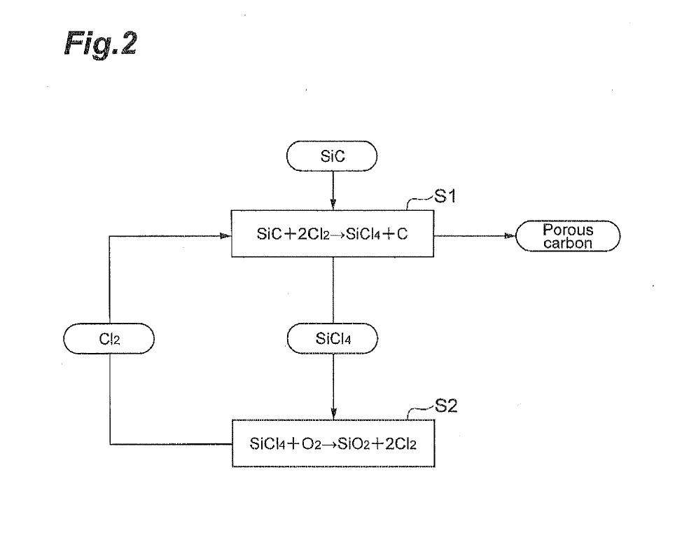

FIGS. 1 and 2 are diagrams showing the principal steps in a method for fabricating a porous carbon material according to one embodiment. Referring to FIG. 1, the method for fabricating a porous carbon material has a first step S1, a second step S2 and a third step S3. According to the method for fabricating a porous carbon material, a porous carbon material is produced by cyclically carrying out the step S1, the step S2 and the step S3. The explanation of a method for fabricating a porous carbon material from silicon carbide will be made below as an example.

In the first step S1, the metal carbide, such as silicon carbide, is reacted with a first gas. The metal carbide contains carbon and a metal element as constituent elements. In the first step S1, silicon in the silicon carbide is reacted with chlorine in the first gas. As a result of this reaction, silicon tetrachloride (SiCl₄) and carbon (C) are produced. This reaction is represented by chemical formula (1) below. The free energy ΔG in this reaction is −430 kJ.

SiC+2Cl₂→SiCl₄+C (1).

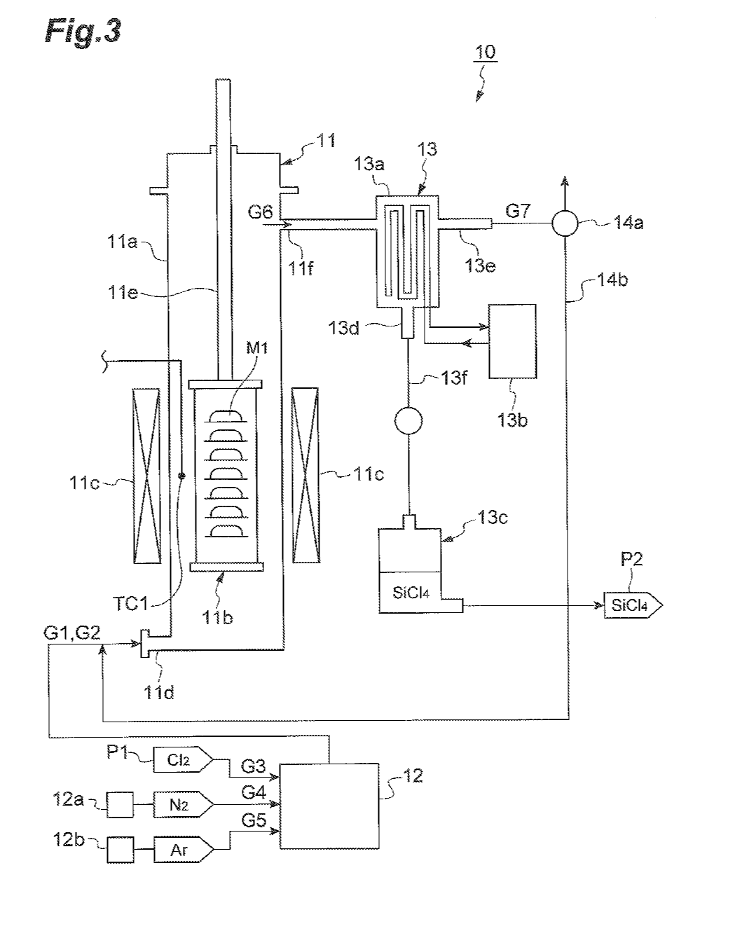

An explanation of a metal carbide processing apparatus 10 will now be made. The metal carbide processing apparatus 10 is used to carry out the first step S1. FIG. 3 is a schematic view showing the constitution of the metal carbide processing apparatus 10.

The metal carbide processing apparatus 10 comprises a reactor 11, a gas supplying apparatus 12 and a cold trap 13. The gas supplying apparatus 12 is connected to one end of the reactor 11. The cold trap 13 is connected to another end of the reactor 11.

The reactor 11 includes a core tube 11a, a mounting shelf 11b and a heater 11c. The internal pressure in the core tube 11a is maintained at, for example, atmospheric pressure. The core tube 11a is disposed so as to extend in the vertical direction and comprises, for example, a quartz glass tube. The top (one end) of the core tube 11a is provided with a gas exhaust port 11f. The gas exhaust port 11f is connected to the cold trap 13. The bottom (the other end) of the core tube 11a is provided with a gas inlet port 11d. The gas inlet port 11d is connected to the gas supplying apparatus 12.

The mounting shelf 11b is disposed in the core tube 11a. The mounting shelf 11b is fixed to one end of a support rod 11e, and is hanged from the inner wall of the core tube 11a. The other end of the support rod 11e extends to the outside of the core tube 11a. The other end of the support rod 11e can be operated to move the mounting shelf 11b to the core tube 11a. The mounting shelf 11b has plural mounting plates. The plural mounting plates are arranged in the direction in which the core tube 11a extends. Silicon carbide M1 is placed on the mounting plates.

The heater 11c is disposed outside the core tube 11a so as to surround the mounting shelf 11b. The heater 11c can heat a first gas G1 contained in the core tube 11a. The first gas G1 is heated by the heater 11c such that the temperature of the first gas reaches, for example, 50 degrees Celsius or higher and 1500 degrees Celsius or lower. Here, when the silicon carbide M1 is used as the metal carbide, the heater 11c heats the first gas G1 such that the temperature of the first gas reaches 1000 degrees Celsius or higher and 1300 degrees Celsius or lower. The temperature of the first gas G1 can be measured using, for example, a thermocouple (TC1). The thermocouple TC1 is disposed close to the mounting shelf 11b in the core tube 11a.

The gas supplying apparatus 12 can feed the first gas G1 and an purge gas G2 to the gas inlet port 11d (a port for supplying gas) located on the core tube 11a. More specifically, the gas supplying apparatus 12 controls the initiations and terminations of supplies of the first gas G1 and the purge gas G2. Furthermore, the gas supplying apparatus 12 controls the flows of the first gas G1 and the purge gas G2.

The first gas G1 may be a gas which contains chlorine gas G3 as a constituent. The first gas G1 can be a mixed gas of chlorine gas G3 and an inert gas, or a gas consisting of the chlorine gas G3 of essentially 100% purity. For example, nitrogen gas (N₂), argon gas (Ar), helium gas (He), neon gas (Ne) and xenon gas (Xe) can be used as the inert gas. The purge gas G2 can be an inert gas, such as nitrogen gas G4 or argon gas G5.

The chlorine gas G3, the nitrogen gas G4 and the argon gas G5 is supplied to the gas supplying apparatus 12 in the present example. The chlorine gas G3 is supplied to the gas supplying apparatus 12 from a metal oxide processing apparatus 20, which will be described later. In order to supply a deficiency of chlorine gas due to a series of repetitions of the steps S1 to S3, the gas supplying apparatus 12 is connected to an external chlorine gas source and is, if necessary, supplied with chlorine gas from the external chlorine gas source. The nitrogen gas G4 is supplied to the gas supplying apparatus 12 from a nitrogen gas source 12a. The argon gas G5 is supplied to the gas supplying apparatus 12 from an argon gas source 12b.

The cold trap 13 recovers silicon tetrachloride (in liquid state) from a mixed gas G6. The mixed gas G6 is exhausted from the reactor 11. The mixed gas G6 contains chlorine gas G3, nitrogen gas G4, and silicon tetrachloride (in gaseous state).

The cold trap 13 has a container 13a, a coolant 13b and a tank 13c. The container 13a provides a cavity in which the mixed gas G6 is temporarily stored. The pressure in the container 13a is set to, for example, atmospheric pressure. The container 13a has a first outlet port 13d and a second outlet port 13e. The first outlet port 13d discharges silicon tetrachloride (liquid state). The first outlet port 13d is connected to the tank 13c via pipework 13f. The second outlet port 13e discharges a mixed gas G7. The second outlet port 13e is connected to the gas inlet port 11d of the reactor 11 via a three way valve 14a and a pipework 14b.

The coolant 13b cools the mixed gas G6 that has been introduced into the container 13a. The temperature of the coolant 13b falls within a temperature range that is equal to or higher than the melting point of the metal chloride, such as silicon tetrachloride, and equal to or lower than the boiling point of the metal chloride, and is set to be a temperature that is higher than the boiling point of chlorine. For example, silicon tetrachloride has a melting point of −70 degrees Celsius and a boiling point of +57.6 degrees Celsius. The boiling point of chlorine is −34 degrees Celsius. Therefore, the temperature of the coolant 13b is set to fall within the range of −34 degrees Celsius to +57.6 degrees Celsius. For example, the temperature of the coolant 13b is set to −20 degrees Celsius in the present embodiment. Moreover, the metal chloride contains chlorine and a metal element as constituent elements.

Explanation of the first step S1 shown in FIG. 1 will be made below. The metal carbide processing apparatus 10 is used to carry out the step S1. First, the silicon carbide M1 is placed on each mounting shelf 11b. This silicon carbide M1 can have a powdered, fibrous or lamellar form. The reaction represented in the chemical formula (1) progresses from the surface towards the interior of the silicon carbide M1. Using silicon carbide M1 of particles with small diameters can shorten the period of time required for the reaction. It is preferable that the silicon carbide M1 be in the form of powder particles with diameters of 100 μm or less.

Next, the gas supplying apparatus 12 is controlled to supply the first gas G1 to the core tube 11b. The first gas G1 contains the chlorine gas G3 and the nitrogen gas G4. The gas supplying apparatus 12 sets the flow rate of the chlorine gas G3 to 500 ml/min. The gas supplying apparatus 12 sets the flow rate of the nitrogen gas G4 to 5000 ml/min. Meanwhile, the heater 11c is controlled to heat the first gas G1. The first gas G1 is heated at a temperature in the range of 500 degrees Celsius to 1500 degrees Celsius, and more preferably 1000 degrees Celsius to 1300 degrees Celsius. The first gas G1 is heated, for example, to a temperature of 1100 degrees Celsius. The silicon carbide M1 is subjected to the first gas G1 for a prescribed period of time. Here, the “prescribed period of time” means a period of time by which substantially all the silicon component of the silicon carbide M1 have been reacted with the chlorine. For example, by exposing the silicon carbide M1 to the first gas G1 for 80 minutes at a temperature of 1100 degrees Celsius, all the silicon component of the silicon carbide M1 have been reacted with the chlorine to completely produce the porous carbon material. Accordingly, the prescribed period of time is set to, for example, 120 minutes.

During the chemical reaction in which the silicon carbide M1 reacts with the first gas G1, the mixed gas G6 is discharged from the gas exhaust port 11f. This mixed gas G6 contains the chlorine gas G3, the nitrogen gas G4, and silicon tetrachloride (in gaseous state). The mixed gas G6 is fed to the container 13a of the cold trap 13. The mixed gas G6 in the container 13a is cooled by the coolant 13b. Here, the pressure in the container 13a is kept to atmospheric pressure. The temperature of the coolant 13b is set to a temperature of −50 degrees Celsius or higher and 10 degrees Celsius or lower. The temperature of the coolant 13b is, for example, −20 degrees Celsius. This results in that the silicon tetrachloride is cooled to become liquefied and is recovered to be collected in the tank 13c.

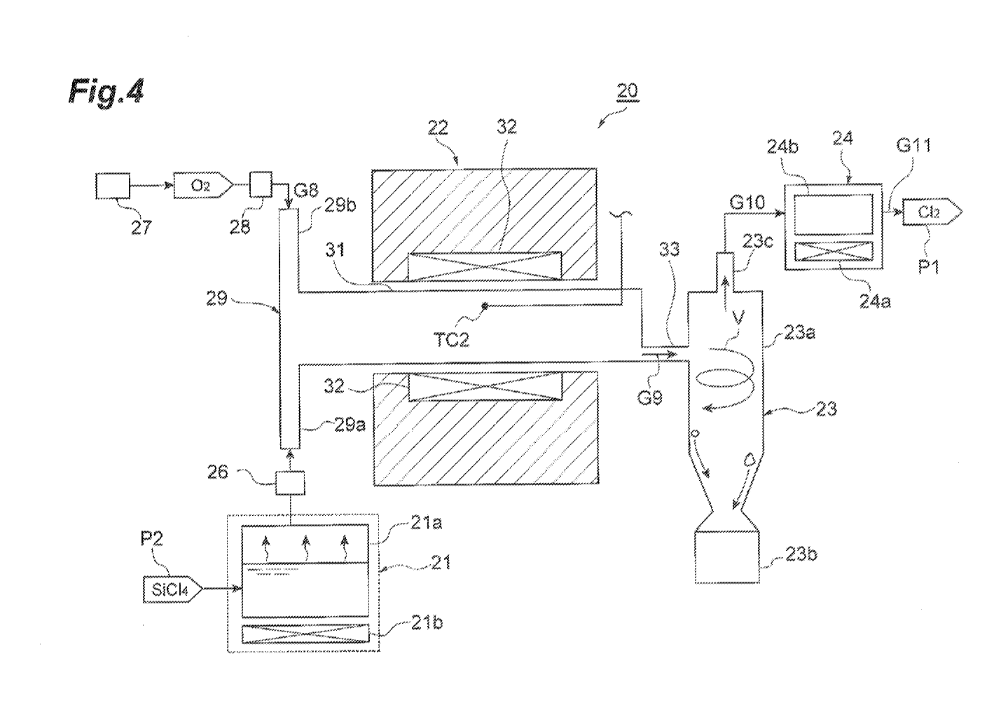

Referring to symbol P2 in FIG. 3, the silicon tetrachloride (in liquid state) in the tank 13c is sent to the metal chloride processing apparatus 20 (refer to FIG. 4). Meanwhile, the mixed gas G7, which contains the chlorine gas G3 and the nitrogen gas G4, is discharged through the second outlet port 13e of the container 13a. The mixed gas G7 is sent via the three way valve 14a and the pipework 14b to the gas inlet port 11d of the reactor 11.

After the reaction between the silicon carbide M1 and the first gas G1 is completed, the gas supplying apparatus 12 is controlled to terminate the supply of the first gas G1. Next, the gas supplying apparatus 12 is controlled to supply the purge gas G2 to the core tube 11a. The purge gas G2 can be a gas consisting of argon gas of substantially 100% purity. This supply can replace an atmosphere in the core tube 11a with an argon atmosphere. Next, the support rod 11e is operated in the reactor 11 to move the mounting shelf 11b upward with reference to the position of the heater 11c. The heater 11c is controlled to lower the temperature of the purge gas G2 to 400 degrees Celsius. Once the temperature of the purge gas G2 has reached 400 degrees Celsius, the porous carbon material is removed from the mounting shelf 11b.

In the step S1, the carbon component of the silicon carbide reacts with the chlorine component of the first gas G1. This chemical reaction allows silicon of the silicon carbide to be extracted therefrom, thereby producing the porous carbon material of a reaction product. The reaction shown in chemical formula (1) is promoted at a temperature of 1000 degrees Celsius or higher. Meanwhile, the specific surface area of porous carbon materials thus produced depends on temperature used in fabricating the relevant porous carbon material. The specific surface area is based on the BET theory (polymolecular layer adsorption theory). A porous carbon material with a high specific surface area can be used effectively as active carbon.

For example, the processing carried out at a temperature of 1150 degrees Celsius to 1250 degrees Celsius provided the porous carbon material with a maximum specific surface area. The maximum specific surface area fell within the range 1200 m²/g to 1700 m²/g, whereas the processing carried out at a temperature of 1400 degrees Celsius or higher the specific surface area provided the porous carbon material with the specific surface area of 800 m²/g to 1000 m²/g. This reason is that when the process is carried out at a temperature of 1400 degrees Celsius or higher, the structure of the porous carbon material changes from an amorphous structure to a graphite structure. This change is effective in producing an active carbon which requires a graphite structure.

Moreover, as in the present embodiment, the specific surface area of the porous carbon material with 1250 m²/g was produced when the temperature of the first gas G1 was 1100 degrees Celsius. The specific weight of the porous carbon material was 0.98 g/cm³.

The explanation of the second step S2 will be made below. In the second step S2, the metal chloride is reacted with the second gas. More specifically, the silicon component of the silicon tetrachloride is reacted with the oxygen component of the second gas. Carrying out this reaction produces silicon oxide (SiO₂) and a third gas (a mixed gas G9). The third gas (the mixed gas G9) contains chlorine as a constituent. The reaction in the step S2 is represented by the following chemical formula (2). The free energy (ΔG) in this reaction is −190 kJ.

SiCl₄+O₂→SiO₂+2Cl₂ (2).

The explanation of the metal chloride processing apparatus 20 will be made below. The metal chloride processing apparatus 20 can be used to carry out the second step S2 and the third step S3. FIG. 4 is a schematic view showing the constitution of the metal chloride processing apparatus 20. The metal chloride processing apparatus 20 comprises a vaporizer 21, a reactor 22, a centrifugal separator 23 and a chlorine recovery apparatus 24. The vaporizer 21 is connected to one end of the reactor 22, and the centrifugal separator 23 is connected to another end of the reactor 22. The chlorine recovery apparatus 24 is connected to the centrifugal separator 23.

The vaporizer 21 can vaporize silicon tetrachloride (in liquid state). The vaporizer 21 is connected to the tank 13c of the processing apparatus 10, which is used to treat the metal carbide (refer to reference symbol P2 in FIG. 3 and reference symbol P2 in FIG. 4). The vaporizer 21 is connected to the reactor 22 via a first flow control section 26. The first flow control section 26 controls the flow rate of the silicon tetrachloride (in gaseous state) to be supplied to the reactor 22.

The vaporizer 21 is used in order to heat silicon tetrachloride (in liquid state) to cause the vaporization thereof. The silicon tetrachloride (in liquid state) is supplied thereto from the tank 13c of the metal carbide processing apparatus 10. The vaporizer 21 heats the silicon tetrachloride by use of a heater 21b. The temperature of the heater 21b is set to a temperature which is higher than the boiling point of the metal chloride. The boiling point of the silicon tetrachloride used in the present embodiment is 57.6 degrees Celsius.

The reactor 22 has an inlet section 29, a core tube 31, a heater 32 and an exhaust section 33. The inlet section 29 is provided at one end of the core tube 31. The exhaust section 33 is provided at the other end of the core tube 31. Silicon tetrachloride (in gaseous state) and a second gas G8, which contains oxygen as a constituent element, are supplied from the inlet section 29. The silicon tetrachloride (in gaseous state) reacts with the second gas G8 while flowing from the inlet section 29 to the exhaust section 33.

The inlet section 29 has a first inlet port 29a and a second inlet port 29b. The first inlet port 29a is connected to the vaporizer 21 via the first flow control section 26. The second inlet port 29b is connected to a gas source 27 via a second flow control section 28. The gas source 27 supplies oxygen gas. The second flow control section 28 controls the flow rate of oxygen gas to be supplied to the second inlet port 29b.

The heater 32 is disposed outside the core tube 31 so as to surround the core tube 31. This heater 32 can heat the silicon tetrachloride (in gaseous state) and the second gas G8. The temperature of the silicon tetrachloride (in gaseous state) and the second gas G8 is measured using a thermocouple TC2 disposed in the core tube 31. The heater 32 is controlled such that the temperature measured by the thermocouple TC2 falls within a temperature of 800 degrees Celsius or higher and 1500 degrees Celsius or lower, for example, 1100 degrees Celsius.

The exhaust section 33 is connected to the centrifugal separator 23. The exhaust section 33 discharges the mixed gas G9. The mixed gas G9 contains fine particles of silicon oxide along with oxygen gas and chlorine gas.

The centrifugal separator 23 can separate a powdery solid material from the mixture containing gas and powdery solid particles. The centrifugal separator 23 can be, for example, a cyclone type apparatus. In the present embodiment, the centrifugal separator 23 separates fine particles of silicon oxide from the mixed gas G9. The centrifugal separator 23 includes a main body section 23a and a tank 23b. A side wall of the main body section 23a is connected to the exhaust section 33 of the reactor 22. The tank 23b is connected to the bottom of the main body section 23a. The tank 23b stores fine particles of silicon oxide. A gas exhaust section 23c is provided at the top of the main body section 23a. The gas exhaust section 23c is used to discharges a mixed gas G10. The mixed gas G10 is the residual which silicon oxide is removed from the mixed gas G9 to produce. The mixed gas G10 contains oxygen gas, chlorine gas and the unreacted silicon tetrachloride.

The chlorine recovery apparatus 24 is connected to the gas exhaust section 23c. The chlorine recovery apparatus 24 recovers chlorine gas from the mixed gas G10. Specifically, this apparatus can remove oxygen gas contained in the mixed gas G10 and enables the recovery of chlorine gas from the mixed gas G10. The chlorine recovery apparatus 24 includes a heater 24a and a section of active carbon 24b. The heater 24a heats the mixed gas G10. In the present embodiment, the mixed gas G10 is heated by the heater 24a to a temperature within the temperature range of 500 degrees Celsius to 1000 degrees Celsius, for example, 800 degrees Celsius. The active carbon 24b adsorbs oxygen gas, so that the chlorine recovery apparatus 24 provides chlorine gas G11. The chlorine gas G11 is fed to the gas supplying apparatus 12 of the metal carbide processing apparatus 10 via the pipework P1.

In another method, the amount of oxygen gas to be supplied in the second step S2 is equal to or lower than a quantity for the complete reaction that completely consumes all the supplied quantity of silicon tetrachloride (in terms of molar ratio, O₂/SiCl₄<1.0). That is, the oxygen gas is supplied in the second step S2 at a quantity that is smaller than a stoichiometric ratio of the metal chloride. This supplied amount of oxygen gas can reduce the concentration of oxygen in the mixed gas G10 in the step carried out after the second step S2. In this case, residual silicon tetrachloride contained in the mixed gas G10 may also be aggregated, but may be supplied without further treatment to the metal carbide processing apparatus 10, which is used in the first step S1.

The explanation of the second step S2 shown in FIG. 1 will be made below. The metal chloride processing apparatus 20 is used to carry out the step S2. First, the second gas G8 is supplied to the core tube 31. The second flow control section 28 is controlled to set the flow rate of the second gas G8 to 490 ml/min. Next, the heater 32 is controlled to set the temperature of the second gas G8 to 1100 degrees Celsius. The temperature of the second gas G8 is measured using the thermocouple TC2 in the core tube 31.

After the temperature of the second gas G8 reaches 1100 degrees Celsius, silicon tetrachloride is supplied to the core tube 31. More specifically, the temperature of the heater 21b in the vaporizer 21 is set to 80 degrees Celsius to vaporize silicon tetrachloride (in liquid state) in the container 21a. The flow rate of silicon tetrachloride (in gaseous state) is set to 500 ml/min by controlling the first flow control section 26.

The silicon tetrachloride is supplied to the core tube 31, so that the silicon component of the silicon tetrachloride reacts with the oxygen component of the second gas G8. This reaction produces fine particles of silicon oxide. These fine particles of silicon oxide have sizes of approximately 0.1 μm to 0.5 μm. In the above reaction, chlorine gas is produced along with the silicon oxide. The fine particles of silicon oxide are introduced along with the oxygen gas and the chlorine gas into the centrifugal separator 23 via the exhaust section 33. These fine particles of silicon oxide with sizes such as that mentioned above can be therefore carried into the centrifugal separator 23 on a gas stream.

Vortices of the mixed gas G9 are generated inside the main body section 23a of the centrifugal separator 23. The fine particles of silicon oxide with large masses in the mixed gas G9 collide with the inner walls of the main body section 23a, and then the fine particles of silicon oxide fall due to gravity towards the tank 23b and are stored therein. The mixed gas G10, which is produced by removing the fine particles of silicon oxide therefrom, is supplied from the gas exhaust section 23c thereto. The mixed gas G10 is introduced into the chlorine recovery apparatus 24.

The explanation of the third step S3 shown in FIG. 1 will be made below. In the step S3, the chlorine gas can be recovered at the recovered amount rate of substantially 100% by removing the oxygen from the mixed gas G10. In the chlorine recovery apparatus 24, the mixed gas G10 is heated by the heater 24a to a temperature of 500 degrees Celsius or higher and 800 degrees Celsius or lowers, for example, 600 degrees Celsius. By bringing the heated mixed gas G10 into contact with the active carbon 24b, the oxygen therein is adsorbed by the active carbon 24b, so that the chlorine recovery apparatus 24 discharges the only chlorine gas G11. The chlorine gas G11 thus produced is recycled as chlorine for the first gas G1, which can be used in the reaction in the step S1. For this recycling, the chlorine gas G11 is fed into the gas supplying apparatus 12 of the metal carbide processing apparatus 10 via the pipework P1.

According to the above method for fabricating a porous carbon material, silicon tetrachloride is reacted with oxygen in a heated atmosphere of the second gas G8. This reaction produces the mixed gas G9 from the silicon tetrachloride. The chlorine gas G11 is recovered from the mixed gas G9. The chlorine gas G11 thus recovered is recycled as the chlorine gas G3 in the first gas G1 used to produce the porous carbon material. The fabricating method according to the present embodiment enables the recycle of chlorine gas in such a way as explained above, thereby increasing the quantity of porous carbon material produced per unit quantity of chlorine gas. As a result, the efficient use of chlorine gas can be provided.

The efficient use of chlorine gas can reduce the consumed amount of chlorine gas. The reduction in the consumed quantity of chlorine gas leads to the reduction in the cost of fabricating the porous carbon material. Further, recycling chlorine gas can reduce the discharge of chlorine from the metal carbide processing apparatus 10 to the outside, which results in the reduction of the burden on the environment caused by chlorine.

However, if oxygen is left in the mixed gas G10 and this mixed gas G10 is supplied to the gas supplying apparatus 12, the residual oxygen can react with the porous carbon produced in the first step S1. The occurrence of this reaction may reduce the amount of porous carbon material to be obtained in the first step S1. But, in the fabricating method of the present embodiment, oxygen is removed from the mixed gas G9 in the third step S3. The removal of oxygen can prevent the porous carbon material from being oxidized in the first step S1, thereby suppressing the reduction in the amount of production of porous carbon material.

In the fabricating method according to the present invention, the first gas G1 is heated to a temperature within the range of 1000 degrees Celsius or higher and 1300 degrees Celsius or lower. Using this temperature range can promote the chemical reaction between the silicon carbide M1 and the first gas G1. This can demonstrate the efficient production of the porous carbon material.

In the fabricating method according to the present invention, the second gas G8 is heated to a temperature of 800 degrees Celsius or higher. Using this temperature range can promote the chemical reaction between the silicon tetrachloride and the oxygen, so that chlorine gas can therefore be efficiently produced.

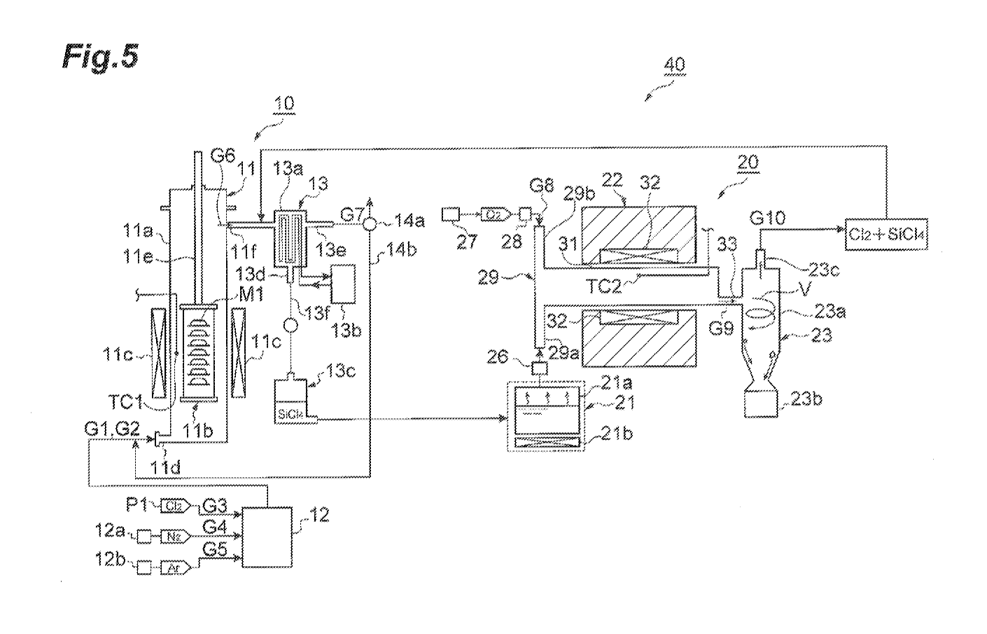

Another method will now be explained. In the other method, the supplied amount of oxygen gas in the second step S2 is equal to or lower than a requisite quantity of oxygen with which all the silicon tetrachloride reacts to be consumed completely (in terms of molar ratio, O₂/SiCl₄<1.0). That is, in the second step S2, the oxygen is supplied at a quantity that is lower than an amount determined by a stoichiometry ratio for the reaction with the metal chloride. Supplying oxygen gas at this quantity can reduce the concentration of oxygen remaining in the mixed gas G10 in the step that is carried out subsequent to the second step S2. In this case, residual silicon tetrachloride contained in the mixed gas G10 may be re-aggregated, but may also be supplied without further treatment to the metal carbide processing apparatus 10 used in the first step S1. FIG. 5 is a block diagram showing a reaction apparatus 40 used for aggregating silicon tetrachloride. Here, the gas produced in the second step S2 (the mixed gas G10) can be refluxed to the apparatus (the cold trap 13) that aggregates SiCl₄, which is produced in the first step S1, and an additional apparatus is not needed for the aggregation.

The oxide produced in the second step S2 may be recycled. That is, the metal oxide obtained in the second step S2 is mixed with the carbon raw material to form a mixture, and the mixture is heated so as to cause the reaction to form a carbide, and this carbide is then used as a carbide raw material in the chlorination in the first step S1. In order to recycle the oxide, the oxide produced in the second step S2 is collected using the centrifugal separator 23, for example, a cyclone type apparatus. The metal oxide powder thus trapped is mixed with carbon to form a mixture, and this mixture is subjected to a reaction under heating to generate a carbide. The carbide obtained here can be supplied again to the first step S1. When silicon is used as the metal, the reaction is represented as follows.

SiO₂+3C→SiC+2CO (3)

In order to facilitate this chemical reaction, the heating temperature should be 1400 degrees Celsius or higher for silicon. The heating temperature should be 1300 degrees Celsius or higher for titanium. That is, silicon or titanium can be applied to the metal element of a carbide, which a mixture formed by mixing the carbon raw material with the metal oxide obtained in the second step S2 is heated so as to cause the chemical reaction to produce, used as a carbide raw material in the chlorination in the first step S1. This heat treatment can be carried out using the reactor 11 shown in FIG. 3. The atmosphere for this heat treatment that contain, as an atmosphere gas, an inert gas (such as N₂ or Ar as mentioned above), and/or a reducing gas, such as carbon monoxide (CO) or hydrogen (H₂), gas has an effect. The treatment may be carried out in a vacuum without a gas flow. The reaction progresses even at a heating temperature of 2000 degrees Celsius or higher, but the particle sizes of the produced carbide become too large, which is not desirable in the first step S1. That is, in the reaction represented by the above chemical formula (3), when the metal oxide obtained in the second step S2 is mixed with a carbon raw material to form a mixture and this mixture is subjected to a reaction under heating to produce a carbide, the temperature in the carbide formation is 1400 degrees Celsius or higher and 2000 degrees Celsius or lower, and an inert gas atmosphere can be used in the formation of the carbide. From the perspective of the characteristics of active carbon, residual oxide undesirably may cause problems such as a reduction in electrical conductivity. Accordingly, in terms of the characteristics of the active carbon of the final product, it is preferable that the carbon be added at a quantity that is greater than the stoichiometric ratio for the reaction.

When a carbon raw material is mixed with the metal oxide from the second step S2 to form a mixture and the mixture is heated so as to carry out the chemical reaction, as represented in formula (3) above, to produce a carbide, the molar ratio between the metal oxide and the carbon is set to be equal to or higher than a stoichiometric ratio in a chemical reaction carrying out the formation of the metal carbide and the production of carbon monoxide gas by consuming the oxygen component thereof.

Moreover, the present invention is not limited to the specific configurations disclosed in the present embodiment.

In addition to the silicon carbide mentioned above, the metal carbide can encompass at least one of aluminum carbide (Al₄C₃), boron carbide (B₄C), silicon carbide (SiC), titanium carbide (TiC), tungsten carbide (WC) and molybdenum carbide (MoC). With these metal carbides, chlorine can cyclically be used in the fabrication of the porous carbon material by use of the metal carbide processing apparatus 10 and metal chloride processing apparatus 20 described above. These metal carbides can be obtained in the same way as with the silicon carbide mentioned above, for example, by mixing a carbon raw material with a metal oxide and then subjecting the obtained mixture to heat treatment either in a vacuum or in an inert gas atmosphere at a temperature of 1000 degrees Celsius or higher. Forming the carbide through a stable oxide, such as aluminum oxide (Al₂O₃) or boron oxide (B₂O₃), may need the treatment at a high temperature of 2000 degrees Celsius or higher. Carbon black or the like is used as the carbon raw material.

For example, for titanium carbide and aluminum carbide, it is preferable that the temperature of the first gas G1 in the first step S1 be set to 500 degrees Celsius or higher and 1000 degrees Celsius or lower and that the temperature of the second gas G8 in the second step S2 be 800 degrees Celsius or higher and 1100 degrees Celsius or lower.

For boron carbide, tungsten carbide and molybdenum carbide, it is preferable that the temperature of the first gas G1 in the first step S1 be set to 600 degrees Celsius or higher and 1000 degrees Celsius or lower and that the temperature of the second gas G8 in the second step S2 be not lower than 1000 degrees Celsius and not higher than 1200 degrees Celsius. Moreover, from the perspectives of forming oxide and ensuring the possibility of a thermodynamic reaction that produce carbide again through the reaction with carbon, among the above series of carbides, silicon carbide and titanium carbide can be preferably used as the metal carbide in the present embodiment.

The method for recovering chlorine in the third step S3 can be, for example, a method involving the use of the cold trap used in the first step S1. Chlorine gas, which is contained in the mixed gas G10, has a boiling point of −34 degrees Celsius, and oxygen gas has a boiling point of −182 degrees Celsius. Cooling the mixed gas G10 to a temperature of approximately −70 degrees Celsius by means of a coolant can liquefy chlorine gas, and the liquefaction allows the recovery of chlorine from the mixed gas G10.

In the present embodiment, silicon tetrachloride is liquefied in the cold trap 13 in the metal carbide processing apparatus 10 and recovered, and the silicon tetrachloride thus recovered is again vaporized by the vaporizer 21 in the metal chloride processing apparatus 20. But, the present invention is not limited thereto. The silicon tetrachloride (in gaseous state) produced in the metal carbide processing apparatus 10 may be supplied directly to the metal chloride processing apparatus 20. That is, the mixed gas G6 supplied from the reactor 11 of the metal carbide processing apparatus 10 may be introduced into the first inlet port 29a of the metal chloride processing apparatus 20.

The principles of the present invention have been illustrated and explained using preferred embodiments, but a person skilled in the art would recognize that the present invention could be modified in terms of configuration and details without deviating from such principles. The present invention is not limited to the specific configuration disclosed in the present embodiment. Therefore, we claim rights to all amendments and alterations obtained from the scope and spirit of the claims.

### INDUSTRIAL APPLICABILITY

The present embodiment provides a method for fabricating a porous carbon material. In this fabricating method, chlorine gas is used efficiently and the burden on the environment caused by chlorine gas can be reduced.

### REFERENCE SIGNS LIST

10 . . . Metal carbide processing apparatus,
11 . . . Reactor,
12 . . . Gas supply apparatus,
13 . . . Cold trap,
14a . . . Three way valve,
20 . . . Metal chloride processing apparatus,
21 . . . Evaporator,
22 . . . Reactor,
23 . . . Centrifugal separator,
24 . . . Chlorine recovery apparatus,
26 . . . First flow control section,
27 . . . Gas source,
28 . . . Second flow control section,
G1 . . . First gas,
G2 . . . Purge gas,
G3 and G11 . . . Chlorine gas,
G4 . . . Nitrogen gas,
G5 . . . Argon gas,
G6 . . . Mixed gas,
G7 . . . Mixed gas,
G8 . . . Second gas,
G9 . . . Mixed gas,
G10 . . . Mixed gas,
M1 . . . Silicon carbide,
S1 . . . First step,
S2 . . . Second step,
S3 . . . Third step.

1. A method for fabricating a porous carbon material, the method comprising the steps of:
exposing a metal carbide to a heated atmosphere of a first gas to produce a porous carbon material and a metal chloride, the metal carbide containing a first metal and carbon, the first gas containing chlorine gas, and the metal chloride containing the first metal and chlorine;
reacting the metal chloride with a second gas in a heated atmosphere to produce a metal oxide and a third gas, the second gas containing oxygen gas, the metal oxide containing the first metal and oxygen, and the third gas containing chlorine gas; and
recovering chlorine gas from the third gas, the chlorine gas recovered being used as the chlorine gas for the first gas,
the oxygen in the second gas being supplied at a quantity that is lower than a stoichiometric ratio of metal chloride.

2. The method according to claim 1, wherein the metal carbide includes at least one of aluminum carbide, boron carbide, silicon carbide, titanium carbide, tungsten carbide or molybdenum carbide.

3. The method according to claim 1, wherein the first gas is heated to a temperature of not lower than 500 degrees Celsius and not higher than 1500 degrees Celsius.

4. The method according to claim 1, wherein the metal carbide is silicon carbide and the first gas is heated to a temperature of not lower than 1000 degrees Celsius and not higher than 1300 degrees Celsius.

5. The method according to claim 1, wherein the second gas is heated to a temperature of not lower than 800 degrees Celsius.

6. (canceled)

7. The method according to claim 1,
wherein the metal oxide is mixed with a carbon raw material to form a mixture, the mixture is heated so as to cause a chemical reaction to produce a carbide, and the carbide is used as a carbide raw material in chlorination producing the metal chloride.

8. The method according to claim 7,
wherein the metal oxide is mixed with a carbon raw material to form a mixture, the mixture is heated so as to cause a chemical reaction to produce a carbide, and the carbide is used as a carbide raw material in chlorination producing the metal chloride, and
wherein the metal chloride contains a metal element of one of silicon and titanium.

9. The method according to claim 7,
wherein the metal oxide is mixed with a carbon raw material to form a mixture and the mixture is heated to a temperature of not lower than 1400 degrees Celsius and not higher than 2000 degrees Celsius so as to cause a chemical reaction of the mixture to produce a carbide, and
wherein a formation of the carbide is carried out in an inert gas atmosphere.

10. The method according to claim 7,
wherein, in a formation of a carbide produced by heating a mixture of the metal oxide with a carbon raw material so as to cause a chemical reaction of the mixture to produce the carbide, a molar ratio between metal and carbon of the mixture is not lower than a stoichiometric ratio between metal and carbon in a reaction producing a metal carbide from the metal oxide by consuming an oxygen component of the metal oxide to produce carbon monoxide gas.
